(19) United States
(12) Patent Application Publication
(10) Pub. No.: US 2024/0075934 A1
(43) Pub. Date: Mar. 7, 2024

(54) SYSTEM AND METHOD FOR COMPUTER AIDED ESTIMATION OF A VALUE FOR TOTAL MASS OF A VEHICLE SYSTEM

(71) Applicant: KNORR-BREMSE Systeme für Nutzfahrzeuge GmbH, Munich (DE)

(72) Inventors: Oliver Jundt, Hessigheim (DE); Ruediger Weis, Stuttgart (DE); Jonas Leibbrand, Niefern-Oeschelbronn (DE)

(21) Appl. No.: 18/244,829

(22) Filed: Sep. 11, 2023

Related U.S. Application Data
(63) Continuation of application No. PCT/EP22/53295, filed on Feb. 10, 2022.

(30) Foreign Application Priority Data
Mar. 26, 2021 (DE) DE102021107705.2

(51) Int. Cl. B60W 30/18; B60W 10/04; B60W 10/10; B60W 10/18; B60W 40/13; B60W 60/00; G01G 19/08

(52) U.S. Cl. CPC B60W 30/18181; B60W 10/04; B60W 10/10; B60W 10/18; B60W 40/13; B60W 60/00; G01G 19/08; B60W 2040/1307; B60W 2530/10; B60W 2530/207; B60W 2710/10; B60W 2710/18

(57) ABSTRACT

A method for the computer-aided estimation or determination of a value for the total mass of a vehicle system, comprising a towing vehicle and possibly at least one trailer coupled to the towing vehicle, wherein physical data relating to the vehicle system, which change depending on a load of the vehicle system and a number of trailers coupled to the towing vehicle are captured, and a first value for the total mass of the vehicle system is estimated or determined as part of a first estimation or determination at a first point in time, in particular irrespective of the physical data, wherein the first value is retained as a valid value for the total mass of the vehicle system or is used as an initial value for a further determination or estimation of the total mass of the vehicle system if it has been identified.

### RELATED APPLICATIONS

This application is a continuation of International Patent Application PCT/EP2022/053295 filed on Feb. 10, 2022 claiming priority from German Patent Application DE 10 2021 107 705.2 filed on Mar. 26, 2021, both which are incorporated in their entirety by this reference.

### FIELD OF THE INVENTION

The invention relates to a system for computer aided estimation of a value for a total mass of a vehicle system and a method for computer aided estimation of a value for total mass of a vehicle system and to a method for computer aided estimation of a value for total mass of a vehicle system.

The invention furthermore relates to a brake and/or vehicle control system and a vehicle system including a towing vehicle and optionally at least one trailer coupled with the towing vehicle and a brake and/or vehicle control system.

### BACKGROUND OF THE INVENTION

Brake and/or vehicle control systems require a precise value for the total mass of the vehicle system in order to be able to run a respective control system with a desired precision. In particular in commercial vehicles total mass may vary considerably due to different loading so that a repeated mass determination is performed in order to be able to support the brake and vehicle control systems.

In case each individual axle of the towing vehicle and of an optionally coupled trailer has an axle load sensor, a total vehicle mass can be determined rather precisely as a sum of axle loads. However, only a small number of towing vehicles and trailers has an axle load sensor at each axle. Typically, an axle load sensor is only provided at a rear axle of the towing vehicle suspended by air suspension bags wherein an air suspension bag pressure correlates with the axle load. Vehicles that are entirely steel sprung typically do not provide a measured axle load.

Direct mass determination at all axles is therefore hardly ever provided due to a lack of axle load sensors. Instead, a total mass of the vehicle system is often estimated. DE 103 07 511 A1 discloses a method for computer-aided estimation of a mass of a vehicle based on an equilibrium relationship between propulsion force and a sum of inertia forces and drive resistances. The mass can therefore be estimated by a simultaneous detection of a drive moment, thus a torque impacting the wheels and a resultant acceleration and/or its derivates. Since friction forces can typically not be determined precisely an exact determination of the mass from these dynamic variables, this means without using a scale, is typically only possible using a multitude of successive measurements. Thus, a more or less precise estimation of the mass is provided at a given point in time. This estimation can be performed e.g. by using the so called RLS (recursive least squares) algorithm or an RLS estimator, wherein the estimation is performed in response to an initiation of the estimator by corresponding input variables. In order to achieve a reliable estimation of the mass, the estimation is improved over a longer time period. This way errors with respect to an instant estimated value can be avoided or their effects can at least be mitigated. These errors can be generated by a change of inclination during subsequent shut down times of the commercial vehicle or by unknown friction with the road and of rotating components of the vehicle and by wind etc.

When the estimator is not informed of a load change an estimated value for the total mass will not coincide with an actual total mass or will only coincide after a very long learning process. This can have considerable consequences for the driving properties of the vehicle. For example, when there is downhill driving after a load change for example without a driver causing an acceleration there can be a critical situation since the required brake force was not yet computed in an optimum way. The mass estimation will only be adapted incrementally to the load change since the memory of the estimator still includes measurement values relating to the obsolete loading and the new input values have not caused the loading correction yet. A driver may consider this situation in a precautionary manner, however, an obsolete measurement value may have negative effects for autonomously running vehicles.

### BRIEF SUMMARY OF THE INVENTION

Therefore, it is a long felt need to estimate and determine a total mass of a vehicle system wherein a change of the loading and a change of a number of trailers coupled with the toying vehicle shall be detected and applied in order to accelerate the estimation process.

Thus, it is an object of the invention to provide a system and a method, for computer-aided estimation or determination of a value for a total mass of a vehicle system which accelerates the estimation of determination process.

The object is achieved by the features of claim 1 and claim 10.

According to a first aspect of the invention, a system for computer-aided estimation or determination is proposed for determining a total mass of a vehicle system including a towing vehicle and optionally at least one trailer coupled to the towing vehicle, the system comprising:
a) a sensor device configured so that sensor signals of the sensor device represent physical data of the vehicle system which varies as a function of a loading of the vehicle system and as a function of trailers coupled to the towing vehicle and which sensor signals enable a determination whether a loading of the vehicle system and a number of trailers coupled to the towing vehicle has changed or not changed between a first point in time (t1) and a second point in time (t2) that is later than the first point in time (t1); and
b) a processing device configured to estimate or determine a first value (W1) for the total mass of the vehicle system in a first estimation at the first point in time (t1) irrespective of the physical data,
c) wherein the processing device is configured to determine from the physical data whether the loading of the vehicle system and the number of trailers coupled to the towing vehicle has changed or has not changed between the first point in time (t1) and the second point in time (t2), and
d) wherein the processing device is configured to
   maintain the first value (W1) as valid value for the total mass of the vehicle system or as an initial value for a subsequent determination or estimation of the total mass of the vehicle system if the processing device has determined based on the physical data that no significant change of the loading of the vehicle system and no change of the number of the trailers coupled to the towing vehicle has occurred between the first point in time (t1) and the second point in time (t2), but
   to estimate or determine a second value (W2) for the total mass of the vehicle system in independently from the physical data during a second estimation or determination subsequent to the first estimation or determination and discard the first value (W1) when the processing device has determined from the physical data that a change of the loading of the vehicle system and/or a change of the trailers coupled to the towing vehicle has occurred between the first point in time (t1) and the second point in time (t2).

A second aspect of the invention relates to a method for computer-aided estimation or determination of a value for a total mass of a vehicle system including a towing vehicle and a number of trailers coupled with the towing vehicle, the method comprising:
a) detecting physical data of the vehicle system which varies as a function of a loading of the vehicle system and as a function of a number of trailers coupled to the towing vehicle and which enable determination whether a loading of the vehicle system and the number of the trailers coupled to the towing vehicle has changed or not changed between a first point in time (t1) and a second point in time (t2) that is later than the first point in time (t1); and
b) estimating or determining a first value (W1) for the total mass of the vehicle system in a first estimation at the first point in time (t1) irrespective of the physical data,
   wherein the first value (W1) is maintained as a valid value for the total mass of the vehicle system or used as an initial value for a subsequent determination or estimation of the total mass of the vehicle system if it has been determined based on the physical data that no significant change of the loading of the vehicle system and no change of the number of the trailers coupled to the towing vehicle has occurred between the first point in time (t1) and the second point in time (t2), but
   wherein a second value (W2) for the total mass of the vehicle system is estimated or determined independently from the physical data during a second estimation or determination subsequent to the first estimation or determination and the first value (W1) is discarded when the processing device has determined from the physical data that a change of the loading of the vehicle system and/or a change of the number of the trailers coupled to the towing vehicle has occurred between the first point in time (t1) and the second point in time (t2).

The number of the trailers coupled with the towing vehicle can have the value zero. Then the vehicle system only includes the towing vehicle or the value of the trailers coupled with the towing vehicle can be any integer figure wherein the number of trailers that can be coupled certainly has an upper limit.

The inventors have found in cases where axle load sensors are not provided at each axle of the vehicle system so that the total mass of the vehicle could be easily determined directly, this means he total mass can be determined from the axle load signals of the axle load sensors, that the total mass can be estimated or determined in particular independently from the physical data with higher quality and the estimated value for the total mass can be used as a valid value as long as the physical data does not change significantly. It suffices for determining the physical data when not all axles of the vehicle system are provided with vehicle load sensors since, it is already possible with few axle load sensors to detect a change of the physical data and thus a change of the loading of the vehicle system. This change of the physical data has the consequence that the value (W1) estimated prior cannot be used for the total mass going forward. Vice versa when the physical data has not changed significantly this indicates that neither the loading nor the number of trailers coupled to the towing vehicle has changed so that the value estimated up to date (W1) is usable for the total mass going forward or continues to be valid.

Put differently, the first value (W1) determined or estimated by the processing device which has high quality is maintained for subsequent computations or as an input value for additional systems and/or for a subsequent estimation or determination when it has been determined from the physical data that the loading condition of the vehicle system has not changed or has not changed significantly and the number of the trailers coupled to the towing vehicle has not changed either.

When the vehicle system is stopped, a value for the total mass of the vehicle system may be provided which has been determined during a prior driving cycle based on an equilibrium relationship between the propulsion force and a sum of the inertial forces and propulsion resistances as a first value. A renewed reading of the total vehicle mass which can be time consuming when a certain estimation quality shall be achieved can be omitted or shortened.

As stated supra the first value for the total mass of the vehicle system can have been determined as the first value based on an equilibrium relationship between the propulsion force and the sum of inertia forces and propulsion resistances.

The features of the dependent claims define advantageous embodiments of the invention.

According to an advantageous embodiment of the invention, the system includes a non-transient data memory and the processing device cooperates with the non-transient data memory so that the processing device
a) writes the first value (W1) for the total mass of the vehicle system and current physical data (Z1) into the non-transient data memory at a first point in time (t1), and
b) determines second physical data (Z2) at a second point in time (t2) and compares the second physical data (Z2) with the first physical data (Z1), and
   discards the first value (W1) and estimates or determines the second value (W2) if the second physical data (Z2) differs from the first physical data (Z1) by more than a predetermined deviation, but
   reads the first value (W1) from the non-transient data memory and maintains the first value (W1) as the valid value for the total mass of the vehicle system if the second physical data (Z2) differs from the first physical data (z1) by the permitted deviation or less than the permitted deviation.

The processing device of the system can be furthermore configured to maintain the first value (W1) as the valid value for the total mass of the vehicle system even when an occurrence of an event has been determined by the processing device between the first point in time (t1) and the second point in time (t2) which could theoretically have caused a change of the total mass of the vehicle system.

Thus, the event can be one of the following events: at least one ignition change of the towing vehicle, advantageously two sequential ignition changes and/or a stand still period of the vehicle system which exceeds a predetermined stand still period of the vehicle system. Put differently this has the effect that the first value (W1) for the total mass is maintained and continues to be used as input value for other systems and no new value for the total mass is estimated or determined in spite of determining an event which could have theoretically led to a change of the total mass of the vehicle system, but actually has not caused a change of the total mass of the vehicle system.

An ignition change of the towing vehicle occurs when the ignition of the towing vehicle is switched off after having been switched on before, for example when a drive engine of the towing vehicle is switched from an “on” condition into an “off” condition. The term “ignition change” or “ignition” has a broad interpretation including towing vehicles with an internal combustion engine as a drive engine, towing vehicles with a combination of internal combustion engine and electric motor and towing vehicles exclusively driven by an electric motor.

The processing device receives e.g. a velocity signal for this purpose from at least one wheel speed sensor of the towing vehicle or of at least one trailer in order to be able to determine the stand still and/or the signal of an ignition switch of the towing vehicle.

A load change can be detected by at least one vibration detector which includes e.g. a vertical detection device and which can then detect vibrations caused by a loading process and feed signals to the processing device.

The sensor device of the system can include the following:
a) at least one axle load sensor at at least one axle of the towing vehicle and/or at at least one axle of the at least one trailer which provides at least one axle load signal as a sensor signal to the processing device and/or
b) a trailer detection which provides information regarding a number of trailers coupled to the towing vehicle as a sensor signal to the processing device, and/or
c) a camera device including at least one camera which is arranged at the towing vehicle and/or at the at least one trailer, so that the camera provides at least one image signal including information regarding the number of the trailers coupled with the towing vehicle, and/or
d) at least one Lidar-sensor or a RADAR sensor which is arranged at the towing vehicle and/or at the at least one trailer so that it provides at least one signal including information regarding the number of trailers coupled with the towing vehicle and/or
e) at least one ultrasound sensor which is arranged at the towing vehicle and/or at the at least one trailer so that it provides at least one signal including information regarding the number of the trailers coupled with the towing vehicle.

In particular, the at least one camera can be advantageously arranged at the towing vehicle so that it detects a rear area of the towing vehicle which provides at least one image signal including information regarding the number of trailers coupled with the towing vehicle. The at least one camera can also be a mirror camera which is arranged in or at a side mirror of the towing vehicle.

Towing vehicles often include a trailer detection which generates a trailer detection signal. The processing device can determine the following from the trailer detection: Trailer availability (trailer detected, not detected, detection not available). The detection method e.g.; current measurement at CAN ISO 11992 PLC, the trailer type (trailer without ABS, with ABS, with EBS), the condition and the availability of the trailer (ABS retarder), the trailer properties which are transmitted e.g. by CAN, ISO11992 from the trailer to the processing device on the towing vehicle, e.g. the trailer type (semi, dolly, etc.), the number of axles, the number of coupled trailers and the trailer geometry, e.g. wheel base.

Wheel load signals from one or plural wheel load sensors of the trailer can be transmitted by CAN ISO11992 from the trailer to the processing device on the towing vehicle.

The invention also relates to a brake system or a vehicle control system or vehicle regulation system which cooperates with the system described supra so that the system delivers the first value (W1) and/or the second value for the total mass of the vehicle system to the brake system or the vehicle control system or the vehicle regulation system.

The brake system or vehicle control system or vehicle regulation system can be in particular an electronically controlled brake system (EBS), dynamic drive control, transmission control, a control for at least partially autonomous driving and/or a coupling force control between the towing vehicle and the at least one trailer.

The invention also relates to a vehicle system, including a towing vehicle and optionally at least one trailer coupled with the towing vehicle and a brake system or vehicle control system or vehicle regulation system.

According to a particularly advantageous embodiment of the vehicle system includes:
a) a towing vehicle and a semi-trailer coupled with the towing vehicle wherein the sensor device at a rear axle and/or at a front axle of the towing vehicle includes at least one axle load sensor but no axle load sensor is provided at the semi-trailer, or
b) a towing vehicle without a coupled trailer, wherein the sensor device at a rear axle or at a front axle of the towing vehicle includes at least one axle load sensor,
c) or a towing vehicle and a semi-trailer coupled with the towing vehicle wherein the sensor device includes at least one axle load sensor at least at one axle of the semi-trailer, but the towing vehicle does not include an axle load sensor, or
d) a towing vehicle with a coupled trailer which is not a semi-trailer but a draw bar trailer.

In particular in these reconfigurations a determination of total mass based solely on axle load signals of the axle sensors as physical data would not be precise enough since not all axles have axle load sensors. Thus, the total mass is estimated independently from the physical data, but the axle load signals are used as physical data for the assessment performed by the processing device whether the physical data has changed between the first point in time (t1) and the second point in time (t2).

In case a) recited supra when only the rear axle of the towing vehicle includes an axle load sensor but there is no axle load sensor at the front axle and at the axle or the axles of the semi-trailer, the support load of the semi-trailer is determined by the axle load sensor at the rear axle of the towing vehicle. The support load then forms part of the physical data and is suitable for the assessment whether the loading of the towing vehicle semi-trailer combination has changed between the first point in time (t1) and the second point in time (t2) or has not changed.

In case b) recited supra where only a towing vehicle but no trailer is included in the vehicle system, and where the sensor device at a rear axle or a front axle of the towing vehicle includes at least one axle load sensor, the measured axle load at the front axle or at the rear axle forms part of the physical data and is therefore suitable for the determination whether the loading of the towing vehicle has changed or has not changed between the first point in time (t1) and the second point in time (t2).

In case c) recited supra, when the towing vehicle does not include an axle load sensor, but at least one axle of the semi-trailer includes an axle load sensor, the axle load signals of the at least one axle load sensor of the semi-trailer can be transmitted through a data connection e.g. through CAN ISO11992 from the semi-trailer to the processing device at the towing vehicle and checked in the processing device with respect to a possible load change.

In cases a), c) and d) recited supra it can be determined by the trailer detection and/or the camera device whether a semi-trailer or trailer has been decoupled from the towing vehicle or coupled to the towing vehicle between the first point in time (t1) and the second point in time (t2).

An improved method includes
a) storing the first value (W1) for the total mass of the vehicle system in a non-transient memory at the first point in time (t1) and storing the first physical data (Z1) in a non-transient memory, and
b) determining second physical data (Z2) at a second point in time (t2) and comparing the second physical data (Z2) with the first physical data (Z1).
   if determined that the second physical data (Z2) deviates from the first physical data (Z1) by more than a permitted deviation, discarding the first value (W1) and estimating or determining the second value (W2),
   if determined that the second physical data (Z2) deviate from the first physical data (Z1) by a permitted deviation or less than the permitted deviation reading the first value (W1) from the memory and maintaining the first value (W1) as the valid value for the total mass of the vehicle system.

The first value (W1) can be maintained as the valid value for the total mass of the vehicle system when an occurrence of an event has been detected between the first point in time (t1) and the second point in time (t2), wherein the event could theoretically cause a change of the total mass of the vehicle system. The event can be one of the following events: at least one ignition change of the towing vehicle, advantageously two ignition changes in sequence and/or an idle period of the vehicle system which exceeds a predetermined idle period of the vehicle system.

According to another advantageous embodiment of the method or the device the physical data of the vehicle system can be captured as follows:
a) by at least one axle load sensor, at at least one axle of the towing vehicle and/or at at least one axle of the at least one trailer which provides at least one axle load signal as the sensor signal, and/or
b) a trailer detection which delivers information regarding the trailers coupled to the towing vehicle as a sensor signal and/or by a camera device and/or
c) by at least one camera device including a camera (6) which is arranged at the towing vehicle and/or at the at least one trailer 3 so that the camera device provides at least one image signal with information regarding trailers 3 coupled with the towing vehicle 2 and/or
d) at least one LIDAR sensor or a RADAR sensor which is arranged at the towing vehicle and/or at the at least one trailer so that the LIDAR sensor or the RADAR sensor provides a signal with information regarding a number of trailers coupled with the towing vehicle, and/or
e) at least one ultra sound sensor which is arranged at the towing vehicle and/or at the at least one trailer so that the ultrasound sensor provides at least one signal with information regarding the number of trailers coupled with the towing vehicle.

In particular the at least one camera can be arranged at the towing vehicle so that it detects a rear portion of the towing vehicle and provides at least one image signal with information regarding trailers coupled with the towing vehicle. The at least one camera can also be a mirror camera arranged in or at a side mirror of the vehicle.

### BRIEF DESCRIPTION OF THE DRAWINGS

Advantageous embodiments of the invention are now described with reference to a drawing figure, wherein:

FIG. 1 illustrates a schematic view of a system for computer-aided estimation or determination of a value for a total mass of a vehicle system according to an advantageous embodiment;

FIG. 2 illustrates a flow chart of a method for computer-aided estimation or determination of a value for the total mass of a vehicle system according to an advantageous embodiment;

FIG. 3 illustrates a vehicle system including a towing vehicle and a semi-trailer according to a first embodiment, the towing vehicle configured with the system according to FIG. 1, and

FIG. 4 illustrates a vehicle system including a towing vehicle and a semi-trailer according to a second embodiment and configured with the system according to FIG. 1.

### DETAILED DESCRIPTION OF THE INVENTION

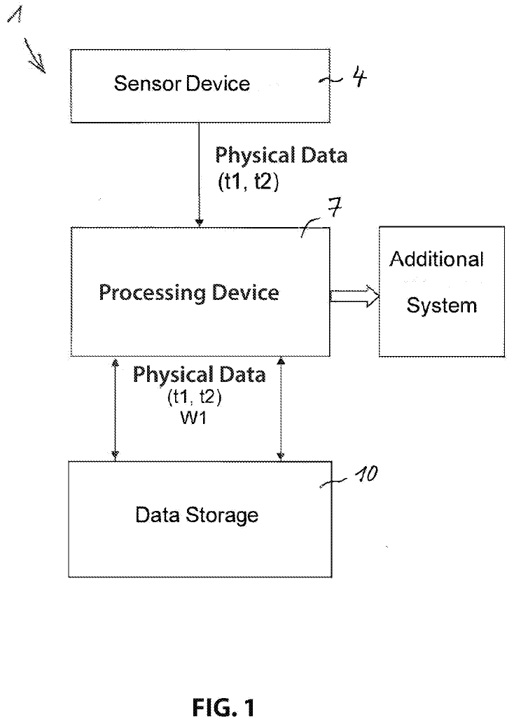

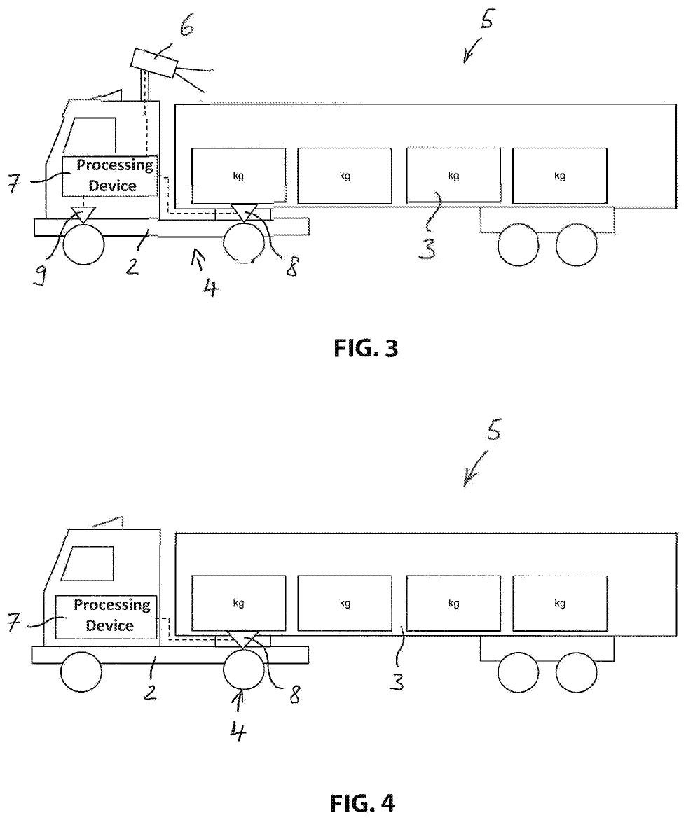

FIG. 1 illustrates a schematic view of a system 1 for computer-aided estimation and determination of a value for the total mass of a vehicle system 5 according to an advantageous embodiment. The vehicle system 5 includes a towing vehicle by itself or a towing vehicle 2 and at least one trailer 3 coupled with the towing vehicle 2 as illustrated in FIGS. 3 and 4.

The system 1 includes a sensor device 4 configured so that sensor signals of the sensor device represent physical data of the vehicle system 5 which change as a function of a loading of the vehicle system 5 and a number of trailers 3 coupled with the towing vehicle 2 and which facilitate a determination whether a loading of the vehicle system 5 and a number of trailers 3 coupled with the towing vehicle 2 has changed or has not changed between a first point in time (t1) and at least one second point in time (t2) that is later than the first point in time (t1).

In the embodiment of FIG. 3 the sensor device 4 includes e.g. a camera 6 which is arranged at the towing vehicle 2 so that it captures a rear portion of the towing vehicle 2 and provides image signals to an electronic processing device 7 arranged e.g. at or in the towing vehicle 2, wherein the processing device 7 is configured to extract information regarding a number of trailers 3 coupled with the towing vehicle. In the instant case, the processing device 7 extracts information from the image signals of the camera 6, that a trailer 7, in particular a semi-trailer is coupled to the towing vehicle 2. The towing vehicle 2, includes e.g. a front axle and a rear axle and the semi-trailer includes two rear axles.

Additionally the sensor device 4 includes at least one rear axle load sensor 8 at the rear axle in the embodiment of FIG. 3 and a front axle load sensor 9 at the front axle of the towing vehicle 2 wherein the rear axle load sensor 8 provides a rear axle load signal to the processing device 7 which includes information regarding a current rear axle load and the front axle load sensor 9 provides a front axle load signal which includes information regarding the current front axle load. In this embodiment the semi-trailer 3, advantageously does not include an axle load sensor.

Additionally or as an alternative to the camera 6 the sensor device can also include trailer detection in the embodiment of FIG. 3, wherein a trailer detection signal for example an ABS signal is provided for example through CAN ISO1199 2 by the semi-trailer 3 to the processing device 7 in the towing vehicle 2, which provides the information to the processing device 7 that a semi-trailer 3 is coupled.

The information regarding the current front axle load, the current rear axle load and regarding the semi-trailer 3 coupled to the towing vehicle 2 form physical data of the vehicle system 5 which is then processed by the processing device 7. This processing includes that the processing device 7 is configured to detect from the physical data whether the loading of the vehicle system 5 and the number of the trailers 3 coupled with the towing vehicle 2 has changed or has not changed between the first point in time t1 and the second point in time t2.

Based on an integrated clock the processing device 7 can furthermore determine a time sequence of the first point in time t1 and the second point in time t2. The first point in time t1 and the second point in time t2 are random points in time, and merely their sequence in time is relevant.

For example, when the camera 6 has detected the semi-trailer 3 at the first point in time t1 but not detected the semi-trailer 3 at the second point in time t2 the processing device 7 processes the corresponding image signals of the camera 6 so that the number of the coupled trailers 3, has changed between the first point in time t1 and the second point in time t2, namely from 1 to zero.

Additionally the processing device 7 can detect from the rear axle and front axle load signals whether the total mass of the vehicle system 5 has changed between the first point in time t1 and the second point in time t2. A load increase of the semi-trailer 3 by itself would cause an increase of at least the rear axle load of the towing vehicle 2 since this increases the support load of the semi-trailer at the support point of the towing vehicle 2 over the rear axle. On the other hand side, a load increase of the towing vehicle 2, would cause a change of the rear axle load, and the front axle load which would in turn be detectable from a changed rear axle load signal and a changed front axle load signal.

Estimation routines are implemented in the processing device 7 which estimate a first value W1 for the total mass of the vehicle system in a first estimate at the first point in time t1 in particular independently from the physical data, this is performed for example by estimating the total mass as a first value W1 in a driving cycle, this means when the vehicle 5 is driving based on an equilibrium relationship between the propulsion force and the sum of inertia forces and propulsion resistances.

Additionally routines are implemented in the electronic processing device 7 wherein the routines maintain the first value W1 as valid value for the total mass of the vehicle system or use the first value W1 as an initial value for a subsequent determination or estimation of the total mass of the vehicle system 5 at the and the second point in time t2, if the routines have determined based on the physical data that no significant change of the loading of the vehicle system 5 and no chance of the number of trailers 2 coupled with the towing vehicle 2 has occurred between the first point in time t1 and the second point in time t2. No change in the loading certainly applies within a tolerance range.

On the other hand side, when the routines of the processing device 7 have determined based on the physical data that a change of the loading of the vehicle system 5 and/or a change of the number of trailers 3 coupled with the towing vehicle 2 has occurred between the first point in time t1 and the second point in time t2, then the processing device 7 estimates a second value W2 for the total mass of the vehicle system 5 independently from the physical data in a second estimation subsequent to the first estimation and discards the first value W1 because the first value W1 is too imprecise due to the change in physical data that has occurred in the meantime.

In the embodiment of FIG. 4, the sensor device does not include a camera 6 which differs from the embodiment of FIG. 3 and does not include a front axle load sensor 9 at the front axle, but only includes a rear axle load sensor 8 at the rear axle. The semi-trailer 3 advantageously does not include an axle load sensor either.

The rear axle load sensor 8 then has a double function in that it provides information to the processing device 7 through its rear axle load signal, whether a semi-trailer 3 is coupled to the towing vehicle 2. In this case the rear axle load sensor 8 can provide information regarding the support load of the semi-trailer 3 in its rear axle load signal and thus also information whether the number of trailers 3 coupled with the towing vehicle 2 has changed between the first point in time (t1) and the second point in time (t2) or has not changed. On the other hand side the rear axle load sensor 8 can also deliver information to the processing device 7 whether the loading of the vehicle system 5 has changed or has not changed between the first point in time (t1) and the second point in time (t2).

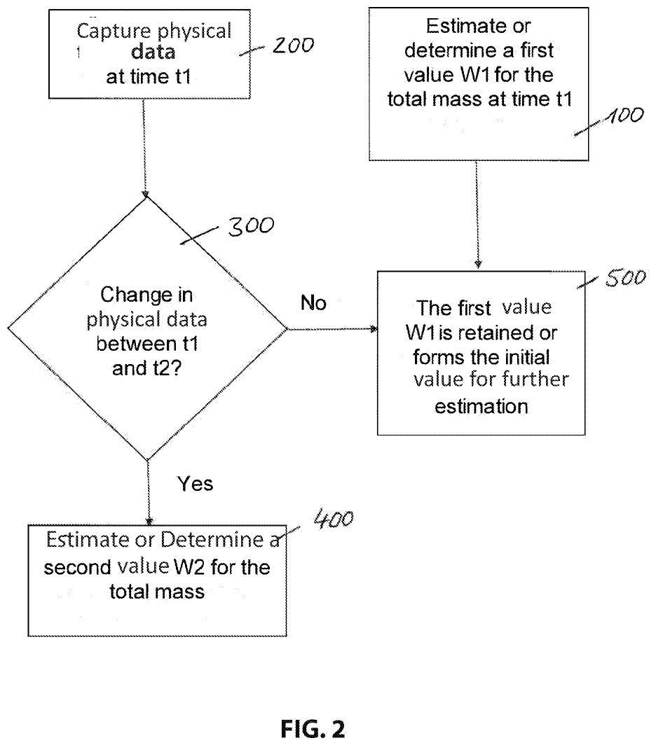

FIG. 2 shows a flow chart of the method for computer-aided estimation of a value for the total mass of a vehicle system 5 according to an advantageous embodiment. The processing device 7 estimates the first value W1 in a step 100 for the total mass of the vehicle system 5 at the first point in time t1. Furthermore the physical data is detected by the sensor device 4 in a step 200 at the first point in time t1 as described supra and fed into the processing device 7.

The processing device 7 checks in a step 300 whether the physical data has changed between the first point in time t1 and the second point in time t2, this means whether sensor signals are provided which indicate a change in of the loading of the vehicle system 5 and/or a change of a number of trailers 3 coupled to the towing vehicle 2, between the first point in time t1 and the second point in time t2. If the answer is yes, the processing device 7 discards the first value W1 which is too imprecise then and cannot provide an initial value for a second estimation and the processing device estimates a second value W2 for the total mass of the vehicle system 5 in a step 400 in a second estimation. If the answer is no, the processing device 7 maintains the first value W1 in a step 500 as the valid value for the total mass of the vehicle system 5 and then advantageously does not perform an additional estimation.

The routines of the processing device 7 can also be configured so that they maintain the first value W1 as the valid value W1 for the total mass of the vehicle system 5 or use the first value W1 as an initial value for a subsequent estimation of the total mass even when the processing device 7 has determined the occurrence of an event which could theoretically have led to a change of the total mass of the vehicle system 5 between the first point in time t1 and the second point in time t2.

The event can be e.g. an ignition of the towing vehicle 2 when a drive engine of the towing vehicle 2 is switched from an on condition into an off condition or vice versa.

This is done with the presumption that the processing device 7 estimates the first value (W1) for the total mass of the vehicle system in a first driving cycle at the point in time (t1) when the drive engine of the towing vehicle 2 is in the on condition and the processing device stores the first value W1 in a non-transitory memory 10 together with the physical data provided at the first point in time t1 as illustrated in FIG. 1. Since the memory 10, e.g. an EEPROM is non transitory the first value (W1) for the total mass and the physical data of the vehicle system 5 is maintained at the first point in time (t1) even when an ignition change from “on” to “off” occurs when the vehicle is being parked for example.

When the vehicle system 5 has been braked from driving to a stop and an ignition change from “on” into “off” condition has occurred, it is to be expected that the stopped or parked vehicle system 5 has been loaded or unloaded after the ignition change.

However, when the drive engine of the towing vehicle is switched from “off” back into the “on” condition at the point in time t2 the processing device 7 reads the physical data determined and stored at the point in time t1 from the memory 10 and compares with the new physical data provided by the sensor device 4 at the point in time t2.

If the physical data relating to the first point in time t1 and the second point in time t2 do not deviate from each other significantly, the processing device 7 reads the first value W1 from the memory 10 and defines the first value W1 as the valid value for the total mass of the vehicle system 5 though the event of the double ignition change from “on” to ‘off’ and from “off” to “on” has justified the presumption that the vehicle system 5 has been loaded or unloaded between the point in time t1 and the point in time t2 and/or the number of the trailers 3 coupled to the towing vehicle 2 has changed.

However, when the physical data related to the first point in time (t1) and the second point in time t2 deviate from each other significantly due to the double ignition change, this indicates that the first value W1 is too imprecise so that the processing device 7 discards the first value W1 e.g. by deleting it from the memory 10 and begins estimating a new second value W2 for the total mass of the vehicle system 5 within the subsequent second driving cycle.

In another embodiment, the event may be that a detected idle period of the vehicle system 5 has exceeded a predetermined idle period of the vehicle system 5. Also here, it can be presumed that the vehicle system 5 has been loaded or unloaded for example with the drive engine running and/or the number of trailers 3 coupled to the towing vehicle 2 has changed between the point in time t1 when the vehicle system 5 has been slowed from a driving condition into a stop condition and the point in time t2 when the vehicle system has been accelerated again from the stopped condition.

Put differently, this prevents that the first value (W1) for the total mass is maintained or continues to be used as an input value for other systems, and no new value for the total mass is estimated or determined in spite of determining at least one event by the processing device 7, which could theoretically lead to a change of the total mass of the vehicle system 5 but has actually not caused a change of the total mass of the vehicle system 5.

In order to detect an event of this type the processing device 7 includes e.g. a velocity signal of at least one wheel speed sensor of the towing vehicle 2 and/or of the trailer 3 in order to determine a stop condition or a driving condition and/or the signal of an ignition switch of the towing vehicle 2.

In the described embodiments, only one respective trailer is coupled to the towing vehicle 2 and forms the vehicle system together with the towing vehicle 2. However, the vehicle system can include the towing vehicle 2 and several trailers 3 but also only the towing vehicle 2. The system according to the invention is therefore combinable with all vehicle systems.

### REFERENCE NUMERALS AND DESIGNATIONS

1 system
2 towing vehicle
3 trailer
4 sensor device
5 vehicle system
6 camera
7 processing device
8 rear axle, axle load sensor
9 front axle, axle load sensor
10 data memory
100-500 method steps
W1 first value
W2 second value
t1 first point in time
t2 second point in time
Z1 first physical data
Z2 second physical data

What is claimed is:

1. A system for computer-aided estimation or determination of a value for a total mass of a vehicle system including a towing vehicle and a number of trailers coupled to the towing vehicle, the system comprising:
a sensor device configured so that sensor signals of the sensor device represent physical data of the vehicle system which varies as a function of a loading of the vehicle system and as a function of the number of trailers coupled to the towing vehicle and which sensor signals enable a determination whether a loading of the vehicle system and the number of trailers coupled to the towing vehicle has changed or not changed between a first point in time and a second point in time that is later than the first point in time; and
a processing device configured to estimate or determine a first value for the total mass of the vehicle system in a first estimation at the first point in time irrespective of the physical data,
wherein the processing device is configured to determine from the physical data whether the loading of the vehicle system and the number of trailers coupled to the towing vehicle has changed or has not changed between the first point in time and the second point in time, and
wherein the processing device is configured to
maintain the first value as a valid value for the total mass of the vehicle system or as an initial value for a subsequent determination or estimation of the total mass of the vehicle system if the processing device has determined based on the physical data that no significant change of the loading of the vehicle system and no change of the number of the trailers coupled to the towing vehicle has occurred between the first point in time and the second point in time, but
estimate or determine a second value for the total mass of the vehicle system irrespective of the physical data during a second estimation or determination subsequent to the first estimation or determination and discard the first value if the processing device has determined from the physical data that a change of the loading of the vehicle system and/or a change of the number of the trailers coupled to the towing vehicle has occurred between the first point in time and the second point in time.

2. The system according to claim 1, further comprising:
a non-transitory data memory wherein the processing device is configured to cooperate with the non-transitory data memory so that the processing device
writes the first value for the total mass of the vehicle system and current physical data into the non-transitory data memory at the first point in time, and
determines second physical data at the second point in time and compares the second physical data with the first physical data, and
discards the first value and estimates or determines the second value if the second physical data differs from the first physical data by more than a predetermined deviation, but
reads the first value from the non-transitory data memory and maintains the first value as the valid value for the total mass of the vehicle system if the second physical data differs from the first physical data by the permitted deviation or less than the permitted deviation.

3. The system according to claim 1, wherein the processing device is configured to maintain or use the first value as the valid value for the total mass of the vehicle system, even if the processing device has detected an occurrence of an event between the first point in time and the second point in time, wherein the event could theoretically have caused a change of the total mass of the vehicle system.

4. The system according to claim 3, wherein the event is at least one of the following events:
at least one ignition change of the towing vehicle, or
an idle period of the vehicle system which exceeds a predetermined idle period of the vehicle system.

5. The system according to claim 1, wherein the sensor device includes:
at least one axle load sensor at least at one axle of the towing vehicle and/or at at least one axle of the at least one trailer which provides at least one axle load signal as the sensor signal, and/or
a trailer detection which delivers information regarding the trailers coupled to the towing vehicle as a sensor signal and/or by a camera device to the processing device, and/or
a camera device including a camera which is arranged at the towing vehicle and/or at the at least one trailer so that the camera device provides an image signal with information regarding the number of trailers coupled with the towing vehicle and/or
at least one LIDAR sensor or RADAR sensor which is arranged at the towing vehicle and/or at the at least one trailer so that the LIDAR sensor or the RADAR sensor provides a signal with information regarding the number of trailers coupled with the towing vehicle, and/or
at least one ultra sound sensor arranged at the towing vehicle and/or at the at least one trailer so that the ultrasound sensor provides at least one signal with information regarding the number of the trailers coupled with the towing vehicle.

6. A brake system or vehicle control system and/or vehicle regulation system that cooperates with the system according to claim 1, so that the system provides the first value and/or the second value for the total mass of the vehicle system to the brake and/or vehicle regulation system.

7. The brake system or vehicle control system or vehicle regulation system according to claim 6, further comprising:
an electronically controlled brake system (EBS);
dynamic drive regulation;
a transmission control; and
a control for at least partially autonomous driving and/or a coupling force regulation between the towing vehicle and the at least one trailer.

8. A vehicle system, comprising:
the towing vehicle and a number of trailers coupled with the towing vehicle; and
the brake system or vehicle control system or vehicle regulation system according to claim 6.

9. The vehicle system according to claim 8, further comprising:
the towing vehicle; and
a semi-trailer coupled with the towing vehicle,
wherein the sensor device at a rear axle and/or at a front axle of the towing vehicle includes at least one axle load sensor but no axle load sensor is provided at the semi-trailer; or
the towing vehicle without a coupled trailer,
wherein the sensor device at a rear axle or at a front axle of the towing vehicle includes at least one axle load sensor; or
or the towing vehicle; and a semi-trailer
coupled with the towing vehicle,
wherein the sensor device includes at least one axle load sensor at least at one axle of the semi-trailer, but the towing vehicle does not include an axle load sensor; or
the towing vehicle with a coupled trailer which is not a semi-trailer but a draw bar trailer.

10. A method for computer-aided estimation or determination of a value for a total mass of a vehicle system including a towing vehicle and a number of trailers coupled with the towing vehicle, the method comprising:
detecting physical data of the vehicle system which varies as a function of a loading of the vehicle system and as a function of the number of trailers coupled to the towing vehicle and which enable determination whether the loading of the vehicle system and the number of the trailers coupled to the towing vehicle has changed or not changed between a first point in time and a second point in time that is later than the first point in time; and
estimating or determining a first value for the total mass of the vehicle system in a first estimation at the first point in time independently from the physical data,
wherein the first value is maintained as a valid value for the total mass of the vehicle system or used as an initial value for a subsequent determination or estimation of the total mass of the vehicle system if it has been determined based on the physical data that no significant change of the loading of the vehicle system and no change of the number of the trailers coupled to the towing vehicle has occurred between the first point in time and the second point in time, but
wherein a second value for the total mass of the vehicle system is estimated or determined independently from the physical data during a second estimation or determination subsequent to the first estimation or determination and the first value is discarded when the processing device has determined from the physical data that a change of the loading of the vehicle system and/or a change of the number of the trailers coupled to the towing vehicle has occurred between the first point in time (t1) and the second point in time.

11. The method according to claim 10, further comprising:
storing the first value for the total mass of the vehicle system and the first physical data in a non-transitory memory at the first point in time; and
determining second physical data at the second point in time and comparing the second physical data with the first physical data,
if determined that the second physical data deviates from the first physical data by more than a permitted deviation, discarding the first value and estimating or determining the second value;
if determined that the second physical data deviates from the first physical data by the permitted deviation or less than the permitted deviation, reading the first value from the memory and maintaining the first value as the valid value for the total mass of the vehicle system.

12. The method according to claim 10, wherein the first value is maintained or used as the valid value for the total mass of the vehicle system, even if the processing device has detected an occurrence of an event between the first point in time and the second point in time, wherein the event could theoretically have caused a change of the total mass of the vehicle system.

13. The method according to claim 12, wherein the event is at least one of the events:
at least one ignition change of the towing vehicle,
an idle period of the vehicle system which exceeds a predetermined idle period of the vehicle system.

14. The method according to claim 10, wherein the physical data of the vehicle system is detected by:
at least one axle load sensor at least at one axle of the towing vehicle and/or at at least one axle of the at least one trailer which provides at least one axle load signal as a sensor signal of the processing device, and/or
a trailer detection which provides information regarding the number of trailers coupled to the towing vehicle as a sensor signal to the processing device, and/or
a camera device including at least one camera arranged at the towing vehicle and/or at the at least one trailer, so that the camera provides at least one image signal including information regarding the number of the trailers coupled with the towing vehicle, and/or
at least one LIDAR-sensor or RADAR-sensor which is arranged at the towing vehicle and/or at the at least one trailer so that it provides at least one signal including information regarding the number of trailers coupled with the towing vehicle and/or
at least one ultrasound sensor which is arranged at the towing vehicle and/or at the at least one trailer so that it delivers at least one signal including information regarding the number of the trailers coupled with the towing vehicle.
